(19) United States
(12) Patent Application Publication
(10) Pub. No.: US 2016/0300307 A1
(43) Pub. Date: Oct. 13, 2016

(54) COMPUTERIZED SYSTEM FOR EFFICIENTLY IDENTIFYING INVESTMENT OPPORTUNITIES FOR NON-MANAGED INVESTMENT ACCOUNTS

(71) Applicant: Bank of America Corporation, Charlotte, NC (US)

(72) Inventor: Steven K. Stearns, Fairfield, CT (US)

(21) Appl. No.: 14/685,127

(22) Filed: Apr. 13, 2015

(51) Int. Cl. G06Q 40/06; G06F 17/30

(52) U.S. Cl. CPC G06Q 40/06; G06F 17/30342

(57) ABSTRACT

Embodiments of the invention are directed to systems, methods, and computer program products for efficiently identifying investment opportunities for non-managed investment accounts. The system typically includes a processor, a memory, and a module stored in the memory. The module is typically configured to determine a score and percentile ranking for each constituent holding in a portfolio; receive threshold conditions from the customer, wherein each threshold condition is associated with a recommended action; determine whether the score and/or the percentile ranking satisfy at least one threshold condition; and generate and alert indicating that the at least one threshold condition has been satisfied and recommend execution of a corresponding action.

### FIELD OF THE INVENTION

The present invention embraces a system to identify investment opportunities for non-managed accounts. Embodiments of the invention are directed to systems, methods, and computer program products for efficiently identifying investment opportunities for non-managed investment accounts. The system typically includes a processor, a memory, and a module stored in the memory to identify investment opportunities based on predetermined thresholds.

### BACKGROUND

Traditionally, an investor has had to choose between an actively managed portfolio in which investments are actively selected to seek a return that outperforms of the market and a passively-managed portfolio in which investments mirror one or more standard market indexes based on market capitalization. Recently, a third investment style, smart beta investing has become more popular. Smart beta investing combines aspects of active and passive portfolio management. Instead of seeking to mirror a standard market index, smart beta investing employs a strategy based on one or more factors in an effort to seek a return and/or reduce volatility in comparison with standard market indexes. For example, a smart beta strategy might weight or screen a standard market index based on one or more factors, such as cash flow, dividends, or volatility. Once the rules for the strategy have been defined, these rules are passively followed. That said, a need exists for an improved way of utilizing smart beta strategies.

### SUMMARY

Embodiments of the present invention address the above needs and/or achieve other advantages by providing apparatuses (e.g., a system, computer program product, and/or other device) and methods for a system to for efficiently identifying investment opportunities for non-managed investment accounts. The present invention enables a user to manage a wide range of assets by quantifying one or more metrics associated with the wide range of assets and provide recommendation for customer investments accordingly.

In one aspect, a system for efficiently identifying investment opportunities for non-managed investment accounts is presented. The system comprises a non-transitory computer-readable storage medium; at least one computer processor; and a module stored in the memory and executable by the computer processor, the module comprising computer-executable instructions for causing the computer processor to be configured to determine asset allocation of a portfolio, wherein the portfolio comprises one or more constituent holdings; retrieve factor data for the one or more constituent holdings from a network of distributed servers, wherein the factor data is associated with one or more smart beta factor models; determine a score for the one or more smart beta factor models for each of the one or more constituent holdings associated with the portfolio based on at least the factor data and the asset allocation; determine a ranking for the one or more smart beta factor models associated with each of the one or more constituent holdings associated with the portfolio based on at least the determined score, wherein the ranking comprises a percentile ranking; receive one or more threshold conditions associated with the portfolio, wherein the threshold conditions are associated with the ranking of the one or more smart beta factor models associated with each of the one or more constituent holdings, wherein each of the one or more threshold conditions are associated with a recommended action, wherein the recommended action is associated with the one or more constituent holdings in the portfolio; determine whether the ranking of the one or more smart beta factor models for each of the one or more constituent holdings associated with the portfolio satisfies at least one of the one or more threshold conditions; and generate an alert on a graphical user interface for display on a user device, wherein the alert comprises an indication that at least one of the one or more threshold conditions for at least one of the one or more constituent holdings associated with the portfolio has been satisfied.

In some embodiments, the module further comprises displaying on the graphical user interface for display on the user device, the ranking for the one or more smart beta factor models associated with each of the one or more constituent holdings associated with the portfolio.

In some embodiments, the module further comprises retrieving from a database, the recommended action associated with the at least one of the one or more threshold conditions; initiating a presentation of a second alert on a graphical user interface for display on a customer device, wherein the second alert comprises the indication that at least one of the one or more threshold conditions associated with the portfolio has been satisfied and the recommended action retrieved from the database; and receiving an authorization from a customer device to execute the recommended action based on at least the second alert.

In some embodiments, the module further comprises receiving an indication from the customer device to modify at least one of the one or more threshold conditions; determining whether the ranking of the one or more smart beta factor models associated with each of the one or more constituent holdings associated with the portfolio satisfies at least one of the one or more modified threshold conditions; generating an alert on a graphical user interface for display on the user device, wherein the alert comprises an indication that at least one of the one or more modified threshold conditions associated with the portfolio has been satisfied.

In some embodiments, the module further comprises receiving an indication from the customer device to modify the recommend action associated with the at least one of the one or more constituent holdings in the portfolio; and updating the recommended action stored in the database with the modified recommended action based on at least the received indication from the customer device.

In some embodiments, the module further comprises continuously retrieving updated factor data for each of the one or more constituent holdings; continuously updating the score for the one or more smart beta factor models associated with each of the one or more constituent holdings associated with the portfolio based on at least continuously retrieving updated factor data and the asset allocation; and continuously updating the ranking of each of the one or more smart beta factor models associated with each of the one or more constituent holdings associated with the portfolio based on at least the continuously updated score.

In some embodiments, the module further comprises receiving an indication from the user device to initiate the execution of the recommended action; execute the recommended action, wherein executing the recommended action comprises modifying at least one of the one or more constituent holdings associated with the portfolio; and determine an updated score and an updated ranking for one or more smart beta factor models associated with each of the one or more constituent holdings associated with the portfolio based on at least receiving an indication that the recommended action has been executed.

In another aspect, a computer program product for efficiently identifying investment opportunities for non-managed investment accounts is presented. The computer program product comprising a non-transitory computer-readable storage medium having computer-executable instructions for causing a computer processor to be configured to determine asset allocation of a portfolio, wherein the portfolio comprises one or more constituent holdings; retrieve factor data for one or more constituent holdings from a network of distributed servers, wherein the factor data is associated with one or more smart beta factor models; determine a score for the one or more smart beta factor models for each of the one or more constituent holdings associated with the portfolio based on at least the factor data and the asset allocation; determine a ranking for the one or more smart beta factor models associated with each of the one or more constituent holdings associated with the portfolio based on at least the determined score, wherein the ranking comprises a percentile ranking; receive one or more threshold conditions associated with the portfolio, wherein the threshold conditions are associated with the ranking of the one or more smart beta factor models associated with each of the one or more constituent holdings, wherein each of the one or more threshold conditions are associated with a recommended action, wherein the recommended action is associated with the one or more constituent holdings in the portfolio; determine whether the ranking of the one or more smart beta factor models for each of the one or more constituent holdings associated with the portfolio satisfies at least one of the one or more threshold conditions; and generate an alert on a graphical user interface for display on a user device, wherein the alert comprises an indication that at least one of the one or more threshold conditions for at least one of the one or more constituent holdings associated with the portfolio has been satisfied.

In yet another aspect, a computerized method for efficiently identifying investment opportunities for non-managed investment accounts is presented. The method comprises determining, using a computing device processor, asset allocation of a portfolio, wherein the portfolio comprises one or more constituent holdings; retrieving, using a computing device processor, factor data for one or more constituent holdings from a network of distributed servers, wherein the factor data is associated with one or more smart beta factor models; determining, using a computing device processor, a score for the one or more smart beta factor models for each of the one or more constituent holdings associated with the portfolio based on at least the factor data and the asset allocation; determining, using a computing device processor, a ranking for the one or more smart beta factor models associated with each of the one or more constituent holdings associated with the portfolio based on at least the determined score, wherein the ranking comprises a percentile ranking; receiving, using a computing device processor, one or more threshold conditions associated with the portfolio, wherein the threshold conditions are associated with the ranking of the one or more smart beta factor models associated with each of the one or more constituent holdings, wherein each of the one or more threshold conditions are associated with a recommended action, wherein the recommended action is associated with the one or more constituent holdings in the portfolio; determining, using a computing device processor, whether the ranking of the one or more smart beta factor models for each of the one or more constituent holdings associated with the portfolio satisfies at least one of the one or more threshold conditions; and generating, using a computing device processor, an alert on a graphical user interface for display on a user device, wherein the alert comprises an indication that at least one of the one or more threshold conditions for at least one of the one or more constituent holdings associated with the portfolio has been satisfied.

### BRIEF DESCRIPTION OF THE DRAWINGS

Having thus described embodiments of the invention in general terms, reference will now be made the accompanying drawings, wherein:

FIG. 1 presents an exemplary block diagram of the system environment, in accordance with embodiments of the present invention;

FIG. 2 illustrates a high level process flow for efficiently identifying investment opportunities for multiple non-managed investment accounts for a user, in accordance with an embodiment of the invention; and

FIG. 3 illustrates an exemplary user interface displaying portfolio data for a plurality of customers, in accordance with an embodiment of the invention.

FIG. 4 illustrates an exemplary user interface displaying the asset data for a customer, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a customer to establish an account with the entity. An “account” may be the relationship that the customer has with the entity. Examples of accounts include a deposit account, such as a transactional account (e.g., a banking account), a savings account, an investment account, a money market account, an insurance account, a time deposit, a demand deposit, a pre-paid account, a credit account, a portfolio, a non-monetary customer profile that includes only personal information associated with the customer, or the like. The account is associated with and/or maintained by an entity. In other embodiments, an “entity” may not be a financial institution.

In some embodiments, the “customer” may be an account holder or a person who has an account (e.g., banking account, credit account, brokerage account or the like) at the entity) or potential customer (e.g., a person who has submitted an application for an account, a person who is the target of marketing materials that are distributed by the entity, a person who applies for a loan that not yet been funded). In other embodiments, the “customer” may refer to an employee of the entity.

In some embodiments, a “user” may be a financial institution employee (e.g., a financial advisor, a financial planner, investment advisor, an underwriter, a project manager, an IT specialist, a manager, an administrator, an internal operations analyst, bank teller or the like) capable of operating the system described herein.

As used herein, a “user interface” may be a graphical user interface. Typically, a graphical user interface (GUI) is a type of interface that allows users to interact with electronic devices such as graphical icons and visual indicators such as secondary notation, as opposed to using only text via the command line. In some embodiments, the graphical user interface may include both graphical elements and text elements.

As used herein, a “constituent holding” may refer to stocks, bonds, mutual funds, exchange traded funds, real estate investment trusts, and the like. In one aspect, a constituent holding may include insurance separate accounts, which are accounts maintained by insurance companies in which a customer having certain insurance products (e.g., variable annuity or variable universal life) can invest, and which are synonymous to mutual funds in which a customer can invest in a retirement account. Typically, the customer has one or more accounts, such as investment, retirement, or brokerage accounts, through which constituent holdings may be purchased. The customer's accounts may be maintained by the financial institution that provides the system and/or by other financial institutions.

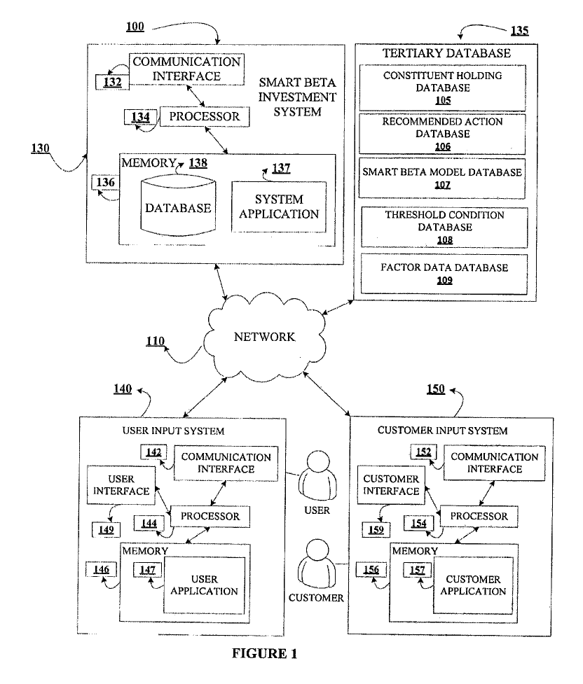

FIG. 1 presents an exemplary block diagram of the system environment 100 for implementing the process flows described herein in accordance with embodiments of the present invention. As illustrated, the system environment 100 includes a network 110, a Smart Beta Investment system 130, a user input system 140, and a customer input system 150. Also shown in FIG. 1 is a user of the user input system 140. The user input system 140 may be a mobile device or other non-mobile computing device. The user may be a person who uses the user input system 140 to execute a user application 147. The user application 147 may be an application to communicate with the Smart Beta Investment system 130 and/or the customer input system 150, perform a transaction, input information onto a user interface presented on the user input system 140, or the like. The customer input system 150 may be a mobile device or other non-mobile computing device. The customer may be a person who uses the customer input system 150 to execute a customer application 157. The customer application 157 may be an application to communicate with the Smart Beta Investment system 130 and/or the user input system 140, perform a transaction, input information onto a user interface presented on the user input system 140, or the like. The customer application 157, user application 147, and/or the system application 137 may incorporate one or more parts of any process flow described herein

As shown in FIG. 1, the Smart Beta Investment system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

The user input system 140 may include any computerized apparatus that can be configured to perform any one or more of the functions of the user input system 140 described and/or contemplated herein. For example, the user may use the user input system 140 to transmit and/or receive information or commands to and from the Smart Beta Investment system 130. In some embodiments, for example, the user input system 140 may include a personal computer system (e.g. a non-mobile or non-portable computing system, or the like), a mobile computing device, a personal digital assistant, a mobile phone, a tablet computing device, a network device, and/or the like. As illustrated in FIG. 1, in accordance with some embodiments of the present invention, the user input system 140 includes a communication interface 142, a processor 144, a memory 146 having an user application 147 stored therein, and a user interface 149. In such embodiments, the communication interface 142 is operatively and selectively connected to the processor 144, which is operatively and selectively connected to the user interface 149 and the memory 146. In some embodiments, the user may use the user application 147 to execute processes described with respect to the process flows described herein. Specifically, the user application 147 executes the process flows described herein.

Each communication interface described herein, including the communication interface 142, generally includes hardware, and, in some instances, software, that enables the user input system 140, to transport, send, receive, and/or otherwise communicate information to and/or from the communication interface of one or more other systems on the network 110. For example, the communication interface 142 of the user input system 140 may include a wireless transceiver, modem, server, electrical connection, and/or other electronic device that operatively connects the user input system 140 to another system such as the Smart Beta Investment system 130. The wireless transceiver may include a radio circuit to enable wireless transmission and reception of information. Additionally, the user input system 140 may include a positioning system. The positioning system (e.g. a global positioning system (GPS), a network address (IP address) positioning system, a positioning system based on the nearest cell tower location, or the like) may enable at least the user input system 140 or an external server or computing device in communication with the user input system 140 to determine the location (e.g. location coordinates) of the user input system 140.

Each processor described herein, including the processor 144, generally includes circuitry for implementing the audio, visual, and/or logic functions of the user input system 140. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 147 of the memory 146 of the user input system 140.

Each memory device described herein, including the memory 146 for storing the user application 147 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 1, the memory 146 includes the user application 147. In some embodiments, the user application 147 includes an interface for communicating with, navigating, controlling, configuring, and/or using the user input system 140. In some embodiments, the user application 147 includes computer-executable program code portions for instructing the processor 144 to perform one or more of the functions of the user application 147 described and/or contemplated herein. In some embodiments, the user application 147 may include and/or use one or more network and/or system communication protocols.

Also shown in FIG. 1 is the user interface 149. In some embodiments, the user interface 149 includes one or more output devices, such as a display and/or speaker, for presenting information to the user. In some embodiments, the user interface 149 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 149 includes the input and display devices of a mobile device, which are operable to receive and display information.

FIG. 1 also illustrates a customer input system 150, in accordance with an embodiment of the present invention. In some embodiments, the customer input system 150 may include a substantially similar structure as that of the user input system 140 to perform any one or more of the functions of the customer input system 150 described and/or contemplated herein. Specifically, the customer input system 150 may include a communication interface 152, a customer interface 159, a processor 154, a memory 156, and a customer application 157.

FIG. 1 also illustrates a Smart Beta Investment system 130, in accordance with an embodiment of the present invention. The Smart Beta Investment system 130 may refer to the “apparatus” or “system” described herein. The Smart Beta Investment system 130 may include any computerized apparatus that can be configured to perform any one or more of the functions of the Smart Beta Investment system 130 described and/or contemplated herein. In accordance with some embodiments, for example, the Smart Beta Investment system 130 may include a computer network, an engine, a platform, a server, a database system, a front end system, a back end system, a personal computer system, and/or the like. Therefore, the Smart Beta Investment system 130 may be a server managed by the business. The Smart Beta Investment system 130 may be located at the facility associated with the business or remotely from the facility associated with the business. In some embodiments, such as the one illustrated in FIG. 1, the Smart Beta Investment system 130 includes a communication interface 132, a processor 134, and a memory 136, which includes a system application 137 and a structured database 138 stored therein. As shown, the communication interface 132 is operatively and selectively connected to the processor 134, which is operatively and selectively connected to the memory 136.

It will be understood that the system application 137 may be configured to implement any one or more portions of the various user interfaces and/or process flow described herein. The system application 137 may interact with the user application 147. It will also be understood that, in some embodiments, the memory includes other applications. It will also be understood that, in some embodiments, the system application 137 is configured to communicate with the structured database 138, the user input system 140, the customer input system 150, or the like.

It will be further understood that, in some embodiments, the system application 137 includes computer-executable program code portions for instructing the processor 134 to perform any one or more of the functions of the system application 137 described and/or contemplated herein. In some embodiments, the system application 137 may include and/or use one or more network and/or system communication protocols.

In addition to the system application 137, the memory 136 also includes the structured database 138. As used herein, the structured database 138 may be one or more distinct and/or remote databases. In some embodiments, the structured database 138 is not located within the system and is instead located remotely from the system. In some embodiments, the structured database 138 stores information or data described herein.

It will be understood that the structured database 138 may include any one or more storage devices, including, but not limited to, datastores, databases, and/or any of the other storage devices typically associated with a computer system. It will also be understood that the structured database 138 may store information in any known way, such as, for example, by using one or more computer codes and/or languages, alphanumeric character strings, data sets, figures, tables, charts, links, documents, and/or the like. Further, in some embodiments, the structured database 138 may include information associated with one or more applications, such as, for example, the system application 137. It will also be understood that, in some embodiments, the structured database 138 provides a substantially real-time representation of the information stored therein, so that, for example, when the processor 134 accesses the structured database 138, the information stored therein is current or substantially current.

It will be understood that the embodiment of the system environment illustrated in FIG. 1 is exemplary and that other embodiments may vary. As another example, in some embodiments, the Smart Beta Investment system 130 includes more, less, or different components. As another example, in some embodiments, some or all of the portions of the system environment 100 may be combined into a single portion. Likewise, in some embodiments, some or all of the portions of the Smart Beta Investment system 130 may be separated into two or more distinct portions.

In addition, the various portions of the system environment 100 may be maintained for and/or by the same or separate parties. It will also be understood that the Smart Beta Investment system 130 may include and/or implement any embodiment of the present invention described and/or contemplated herein. For example, in some embodiments, the Smart Beta Investment system 130 is configured to implement any one or more of the embodiments of the process flows described and/or contemplated herein in connection any process flow described herein. Additionally, the Smart Beta Investment system 130, the user input system 140, or the customer input system 150 is configured to initiate presentation of any of the user interfaces described herein.

As shown in FIG. 1, the system environment 100 includes a tertiary database 135. In some embodiments, the tertiary database 135 may include one or more distinct and/or remote databases. In some embodiments, the tertiary database 135 is not located within the system and is instead located remotely from the system. By way of example, the tertiary database 135 may include a constituent holding database 105, a recommended action database 106, smart beta model database 107, threshold condition database 108, factor data database 109 or the like, which may be maintained by the financial institution or by a third party data provider. In one aspect, such factor databases may be constantly updated (e.g., in real time or periodically), and, accordingly, the updated data may be continuously retrieved from such databases. In another example, the tertiary database 135 may include one or more databases configured to store one or more recommended actions, described herein.

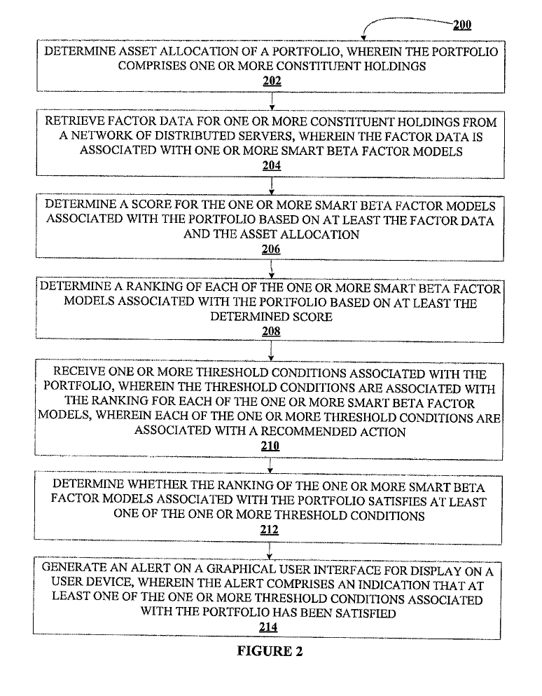

FIG. 2 illustrates a high level process flow for efficiently identifying investment opportunities for multiple investment accounts, typically non-managed investment accounts, for a user 200, in accordance with an embodiment of the invention. Typically, a user (e.g. financial advisor) may manage one or more investment accounts for one or more customers. In some instances, the user may actively build and maintain a customer's investment accounts by making deliberate decisions on assets to buy, sell, or hold. In contrast, in other instances, a customer may have an investment account in which the customer, rather than the user, makes investment decisions (non-managed investment accounts), but the user still provides advice and recommendations to the customer. Although the customer makes final investment decisions for non-managed accounts, the user may still owe the customer the fiduciary duty to provide timely advice and recommendations regarding the customer's investment accounts, which can be very time consuming. The present invention provides the functional benefit of readily identifying investment opportunities for customer investment accounts managed by a user.

As shown in block 202, the process flow includes determining asset allocation of a portfolio, wherein the portfolio comprises one or more constituent holdings. Typically, a portfolio may include a number of different constituent holdings held by a customer. In some embodiments, the constituent holdings may include, but are not limited to different stocks, bonds, real estate holdings, commodities, currencies, and/or cash. In some embodiments, the portfolio may include constituent holdings of the same class category, such as equities or bonds that relate to the same country, region, size (e.g., small, medium, or large), style (e.g., value or growth), or sector (e.g., staples, healthcare, telecomm, utilities, financials, technology, industrial, materials, and the like). In other embodiments, the portfolio may relate to differing asset classes and/or asset class categories. The assets (i.e., constituent holdings) held by the portfolio may be held in equal or unequal proportions. For example, one portfolio may hold 20 stocks with the stocks being held in equal proportions. By way of further example, another portfolio may hold numerous stocks in varying proportions that reflect a market-capitalization-weighted standard stock market index. In some embodiments, the portfolio may include one or more investment accounts associated with the customer, the one or more investment accounts including a number of different constituent holdings. Accordingly, the asset allocation for each portfolio and/or an investment account includes the proportion of each asset held by each portfolio and/or investment account. Each portfolio and/or investment account may be customizable by the user (e.g. financial advisor) and/or the customer (e.g. client). The information necessary to determine asset allocation is typically retrieved from one or more databases (e.g. constituent holding database 105), which may be maintained by a financial institution that maintains the system or by a third party data provider (e.g., another financial institution). Because the constituent holdings of portfolios and/or investment account often change over time (e.g., due to decisions by active managers or customers), such databases (e.g., tertiary database 135) may be regularly updated to ensure that up to date information regarding each constituent holding can be retrieved.

As shown in block 204, the process flow includes retrieving factor data for one or more constituent holdings from a network of distributed servers, wherein the factor data is associated with one or more smart beta factor models. This factor data typically includes financial data, financial ratios, and/or other metrics regarding each constituent holding. By way of example, such factor data may include various metrics such as price, earnings, cash flow, market capitalization, volatility, price to earnings, price to book value, dividend yield, and the like for any period of time, or a combination of time periods. In some instances, such factor data may include rankings, projections, and/or recommendations from analysts. In some embodiments, the smart beta factors may include, but are not limited to, value, momentum, quality, capital stewardship (e.g., yield or growth), and/or trend strength. Factor data related to the value beta factor may include, but are not limited to: intrinsic value, relative value, price to book, price to earnings, price to cash flow, price to sales, and projected total return. Factor data related to the momentum beta factor may include: trailing total return, composite price momentum, and analyst revision momentum. Factor data related to the quality beta factor may include: return on capital, return on equity, earnings quality, and beta. Factor data related to the capital stewardship beta factor may include: shareholder yield, dividend year, buyback yield, dividend growth, historical dividend growth, projected dividend growth, dividend quality, and projected earnings growth. Factor data related to the trend strength beta factor may include various technical indicators. In some embodiments, the factor data may be retrieved from one or more databases (e.g., factor data database 109, smart beta model database 107), which may be maintained by the financial institution or by a third party data provider. Because some of the metrics (e.g., the market price of constituent holdings) may be constantly changed, such factor databases 109 may be constantly updated (e.g., in real time), and, accordingly, updated factor data may be continuously retrieved from such factor databases 109.

As shown in block 206, the process flow includes determining a score for one or more smart beta factor models associated with the portfolio based on at least factor data for each asset and the portfolio asset allocation. In addition, a score for the same smart beta factor models may be determined for one or more customer accounts based on the factor data and the asset allocation within each account. Also, a score for the same smart beta factor model may be determined for each constituent holding based on the factor data. In some embodiments, the score for the one or more smart beta factor models may be a ranking Typically, the ranking may include, but is not limited to a competition ranking, a dense ranking, an ordinal ranking, a fractal ranking, a percentile ranking, or the like. By way of example and for purposes of the invention, “ranking” as used herein, may be a percentile ranking. In some embodiments, the score for the one or more smart beta factor models may be determined based on a multi-factor model. In this regard, the system may be configured to determine a percentile ranking for each of the one or more factors associated with the constituent holdings. Typically, the percentile ranking for each of the one or more factors may be determined by comparing the assessment of each of the one or more factors against the assessment of one or more factors associated with all other asset opportunities available for the customer to invest in. In response, the system may be configured to determine a weighted average of the percentile ranking for the one or more factors to determine the score. In some embodiments, the system may be configured to enable the user and/or the customer to customize the weight assignment to the one or more factors used in determining the score for the one or more smart beta factor models.

Each smart beta factor model typically incorporates one or more beta factors to evaluate the efficacy of investing in one or more constituent holdings in the portfolio and/or the one or more investment accounts, typically over a defined time horizon. For example, a smart beta factor model may be (i) a short term (e.g., 0-6 month investment time horizon) model, (ii) an intermediate term (e.g., 6-24 month investment time horizon) model, a (iii) a long term (e.g., 1-5 year investment time horizon) model, or the like. Such models may also incorporate any fees or transaction costs (e.g., to take into the account the bid-offer spread for a constituent holding) associated with the one or more constituent holdings. In some embodiments, the models are static (i.e., do not change). That said, in other embodiments, the smart beta factor model might be dynamically altered based on changing conditions and/or customized based on user preferences.

In some embodiments, each smart beta factor model may be associated with a rebalancing frequency to determine the most recent percentile rankings associated with the one or more smart beta factor models. Typically, an investment account and/or a portfolio's asset allocation may be a key determinant of the investment account and/or the portfolio's risk and return characteristics. Yet, over time, asset classes may produce different returns resulting in a likely drift of the investment account and/or the portfolio's asset allocation. In this regard, rebalancing the smart beta factor models for each constituent holding, investment account and/or the portfolio may enable the system to determine the most recent percentile rankings associated with the one or more smart beta factor models. In one aspect, rebalancing strategies may incur any fees or transaction costs. In some embodiments, the frequency associated with the rebalancing of the one or more smart beta factor models may vary. In some other embodiments, the frequency associated with the rebalancing of the one or more smart beta factor models may be the same.

As shown in block 208, the process flow includes determining a ranking (e.g. percentile ranking) of each of the one or more smart beta factor models associated with the portfolio, investment account(s), and/or constituent holdings based on at least the determined scores. In one aspect, the score for the one or more smart beta factor models for the portfolio, investment account(s), and/or each constituent holding is compared against the scores of other asset opportunities based on at least the asset classes or class categories to which the constituent holdings relate to determine a percentile ranking Typically, asset opportunities may include any asset, securities, stocks, bonds, or the like, that a customer may invest in. In some embodiments, the customer may have a limited number of asset opportunities in which the customer can invest in. For example, a particular retirement account may only have thirty different constituent holdings in which the customer can invest. In this regard, the score for the one or more smart beta factor models for the portfolio, investment account, and/or each constituent holding may be compared against the scores of asset opportunities which the customer can invest in. In another aspect, the score for the one or more smart beta factor models for the portfolio, investment account, and/or each constituent holding is compared against the scores of all other asset opportunities regardless of the asset classes or class categories to which the asset opportunities relate to determine the percentile ranking.

In some embodiments, the percentile ranking for a portfolio and/or an investment account may be an average (e.g., mean, median, truncated mean, or truncated median) of the percentile ranking of the one or more constituent holdings associated with the portfolio and/or the investment account. In this regard, the average of the one or more constituent holdings may be weighted based on the asset allocation of the portfolio and/or the investment account, resulting in a percentile ranking for the portfolio and/or the investment account based on a weighted average. In some embodiments, the weights associated with the one or more constituent holdings may be customizable by the user and/or the customer.

As shown in block 210, the process flow includes receiving one or more threshold conditions associated with the portfolio, wherein the threshold conditions are associated with the ranking (e.g., percentile ranking) for each of the one or more beta factor models for the portfolio, investment account, and/or each constituent holding. The threshold conditions may also be based on other data such as factor data, transaction cost information, total gain, and other information. The threshold conditions may be retrieved from one or more databases (e.g., threshold condition database 108 for implementation by either the user or the customer and may be unique to the user, the customer, one or more investment accounts, and/or the portfolio. In this regard, the threshold conditions may be customizable by the user and/or the customer and may be configured to be variable at any time by the user and/or the customer with proper authentication credentials. In one aspect, the system may be configured to establish different threshold conditions for each investment account. In some embodiments, the system may be configured to receive one or more threshold conditions associated with each constituent holding and a corresponding recommended action for the same. In one aspect, each threshold condition is associated with a recommended action. In this regard, the recommended action associated with the threshold condition may be stored in a database, which may be maintained by the financial institution or by a third party data provider.

In some other embodiments, the threshold conditions may be established based on one or more characteristics (e.g., trading activity level, transaction costs, or the like) of the customer. In this regard, the threshold conditions may be established based on categorizing the characteristics (e.g., high, medium, or low) of the customer so that the recommended action associated with the established threshold condition maintains the characteristics of the customer.

As shown in block 212, the process flow includes determining whether the ranking (e.g., percentile ranking) of the one or more smart beta factor models associated with the portfolio, investment account, and/or each constituent holding satisfies at least one of the one or more threshold conditions. In response, the process flow includes generating an alert on a graphical user interface for display on a user device, wherein the alert comprises an indication that at least one of the one or more threshold conditions associated with the portfolio and/or each constituent holding has been satisfied, as shown in block 214. In some embodiments, the system may be configured to generate an alert when at least one of the one or more threshold conditions of one or more of the constituent holdings in the portfolio and/or investment accounts are satisfied. The alert may be associated with a particular constituent holding in an investment account and/or a portfolio, a particular investment account in a portfolio, and/or entire the portfolio. In one aspect, the system may be configured to generate an alert for the investment account and/or the portfolio based on at least determining that a threshold condition of the one or more smart beta factor models for at least one associated constituent holding has been satisfied. In some embodiments, the system may be configured to display on the graphical user interface on the user device, the percentile ranking for the one or more smart beta factor models associated with the portfolio, investment account, and/or each constituent holding of the portfolio.

In this way, the present invention provides the functional benefit of readily identifying investment opportunities for customer investment accounts managed by a user. Further, alerting the user based on predefined and customizable threshold conditions may enable the user to address the corrective direction of the portfolio and/or the one or more investment accounts of the user.

In some embodiments, in response to determining that at least one of the one or more threshold conditions have been satisfied, the system may be configured to retrieve from the database 106, the recommended action associated with the at least one of the one or more threshold conditions that have been satisfied. The recommended action may include, but are not limited to selling, buying, holding one or more constituent holdings of the portfolio, and/or placing a constituent holding, the investment account, and/or the portfolio on alert. In one aspect, the recommended action may be accessed as a remote procedure call to request execution of the recommended action when at least one of the threshold conditions is satisfied. In this regard, the system may be configured to append a stub associated with the recommended action to each threshold condition such that the system may be configured to initiate a remote procedure call to retrieve the recommended action from a remote database 106 when at least one threshold condition is met. Typically, the stub may be configured as a local procedure call associated with the recommended action located on a remote database 106. In some embodiments, the system may be configured to retrieve the recommended action based on at least a user authorization. In this regard, the system may be configured to present on the graphical user interface for display on the user device, an authorization prompt to initiate the retrieval of the recommended action from the database 106. In response, the system may receive confirmation from the user to retrieve the recommended action for execution from the database 106.

In some embodiments, the threshold conditions and the corresponding recommended actions may be received from the user and/or the customer. In typical embodiments, a threshold condition with a recommended action of “sell” for a particular constituent holding may be satisfied if the percentile rankings for that holding measured using each smart beta factor model are each below associated defined thresholds. In other words, if for a particular constituent holding has a percentile ranking for any smart beta factor model above an associated defined threshold, then such threshold condition with a recommended action of “sell” would not be satisfied. By way of example, the customer may prefer that each of the one or more constituent holdings in the portfolio have a percentile ranking for quality score and capital score greater than 45 percent. In this case, the customer may request that when the percentile ranking for quality score and/or the capital score of any of the constituent holdings decreases below 45 percent, the corresponding recommended action may be “alert-hold” for a predetermined period of time to monitor the percentile ranking of the capital score. If the percentile ranking of the capital score also decreases below 45 percent when the percentile ranking of the quality score is below 45 within the predetermined period of time, the corresponding recommended action may be “sell”. If the percentile ranking of the quality score increases above 45 percent within the predetermined period of time when the constituent holding is being “held”, the corresponding recommended action may be “remove alert”. In this way, the threshold conditions and the recommended actions may be based on a combination of the scores and/or percentile rankings associated with the smart beta factor models. In some embodiments, the threshold conditions may be established to determine whether at least a portion of the one or more smart beta factor models are over concentrated or under concentrated compared to the remaining portion of the one or more smart beta factor models.

In some embodiments, the system may be configured to establish one or more threshold conditions based at least in part on factor data associated with the one or more constituent holdings, the investment account, and/or the portfolio. As noted, the system may include a threshold condition with a recommended action of “sell” that is triggered for a particular constituent holding if the percentile rankings for that holding measured using each smart beta factor model are each below associated defined thresholds. In addition, the system may include a threshold condition with a recommended action of “charitable gift” that is triggered for a particular constituent holding if the percentage of gain for that constituent holding is above a threshold and the expected total return for that constituent holding is below another threshold. The system may include a threshold condition with a recommended action of “family gift” that is triggered for a particular constituent holding if the percentage of gain for that constituent holding is below a threshold and the expected total return for that constituent holding is greater than another threshold.

In some embodiments, the threshold conditions and the corresponding recommended actions may be based on data received from secondary sources such as recommendation from one or more analysts. Typically, the secondary sources may be sources of information created and/or collected by individuals and/agencies for the purpose of describing, discussing, interpreting, commenting upon, analyzing, evaluating, summarizing, and processing multiple primary sources. Examples of secondary sources include, but are not limited to articles in newspapers, publications, journals, online feeds, or the like. The system may be configured to provide secondary recommendation obtained from secondary sources, in addition to retrieving recommended actions associated with the threshold conditions. In some embodiments, the secondary recommendation may be obtained from recommended actions and threshold conditions associated with portfolios of other customers. In this regard, the system may be configured to determine the threshold conditions for constituent holdings in substantially similar portfolios of one or more other customers and determine secondary recommendations accordingly.

In some embodiments, the system may be configured to initiate a presentation of a second alert on a graphical user interface for display on a customer device. The second alert is an indication that at least one of the one or more threshold conditions associated with the portfolio, investment account, and/or each constituent holding has been satisfied and the corresponding recommended action retrieved from the database 106. The customer device is typically in the possession of the customer who receives the alert substantially simultaneously with the user. In one aspect, the customer may not receive the alert substantially simultaneously with the user. In response to receiving the second alert, the system may be configured to receive an authorization from a customer device to execute the recommended action based on at least the second alert. In one aspect, the authorization may include customer acknowledgement of the recommended action. In this regard, the system may be configured to authenticate his or her identity prior to receiving the authorization. Numerous types and levels of user authentication exist. For example, a customer may authenticate his or her identity using a unique alias such as a username and/or password. Further, in some situations, challenge questions, familiar pictures and/or phrases, biometrics, key fob-based alphanumeric codes and/or collocation, authentication of another application such as a similar application or an “overarching” application, and/or the like may be used as types of identity authentication. In one aspect, the system may be configured to require a combination of two of more user authentications.

In some embodiments, in response to the second alert, the system may be configured to receive an indication from the customer device to modify at least one of the threshold conditions. In response, the system may be configured to determine whether the percentile ranking of the one or more smart beta factor models associated with the portfolio satisfies at least one of the modified threshold conditions. In response to determining the percentile ranking, the system may be configured to generate an alert on a graphical user interface for display on the user device, wherein the alert is an indication that at least one of the modified threshold conditions associated with the portfolio has been satisfied.

In some embodiments, the system may be configured to receive an indication from the customer device to modify the recommend action associated with the at least one of the one or more constituent holdings in the portfolio. In response, the system may be configured to update the recommended action stored in the database 106 with the modified recommended action based on at least the received indication from the customer device.

In one aspect, the system may be configured to regularly (e.g., daily, weekly, monthly, or quarterly) retrieve information regarding each of the one or more constituent holdings from the database 105 or in synchrony with a smart beta model rebalancing schedule (i.e., frequency) in order to score the constituent holdings and the portfolio. For example, the system may continuously (e.g., every few seconds or minutes) retrieve factor data from the database 109 (e.g., receive data from the database via a data stream), thereby allowing the system to continuously update the scores and corresponding percentile ranking of each smart beta factor model associated with the constituent holdings, investment account and/or the portfolio (e.g., in real time). In another example, the system may retrieve factor data from the database 109 periodically (e.g., weekly, monthly, quarterly, annually, or the like) and update the scores and corresponding percentile ranking of each smart beta factor model associated with the constituent holdings, investment account, and/or the portfolio. In this regard, the period associated with the retrieval of factor data may be different for each smart beta factor model. In some embodiments, the period associated with the retrieval of factor data may be similar for each smart beta factor model. Other information regarding the portfolio (e.g., the asset allocation of one or more portfolios) may also be retrieved from the database (e.g., constituent holding database 105). In order for the system to facilitate asset transactions in customer accounts, the system is typically in communication (e.g., via the network) with the financial institution network system. In addition, the system is typically in communication with the banking systems of other financial institutions, thereby allowing the system to direct asset transactions in accounts maintained by such other financial institutions.

In one aspect, transaction costs may be related to threshold conditions. These transaction costs may include fees or any other costs incurred by the customer due to buying or selling an asset (e.g. constituent holding) in a particular account. In this regard, the system may be configured to establish one or more threshold conditions in such a way that the recommended action corresponding to the each threshold condition may enable the customer to minimize the transaction cost. In some embodiments, the threshold conditions may be based on a trading spread associated with the asset allocation. Other costs (e.g., annual fees) associated with the customers' accounts are also typically determined. In this regard, the system may be configured to provide additional recommendation based on at least the transaction costs associated with the customer's constituent holding and/or portfolio. In some embodiments, the additional recommendation may include one or more secondary threshold conditions in addition to the existing threshold conditions. In some other embodiments, the additional recommendation may include one or more secondary threshold conditions to replace the existing threshold conditions. In alternative embodiments, the additional recommendations may be secondary recommendations provided to the user and/or the customer in addition to the recommended actions.

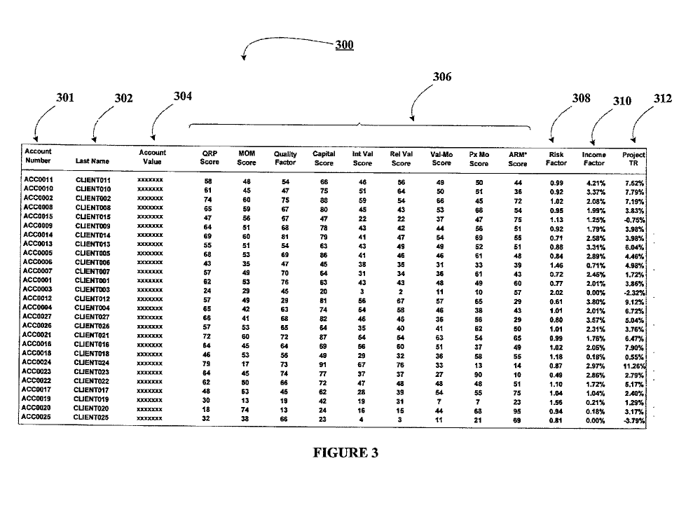

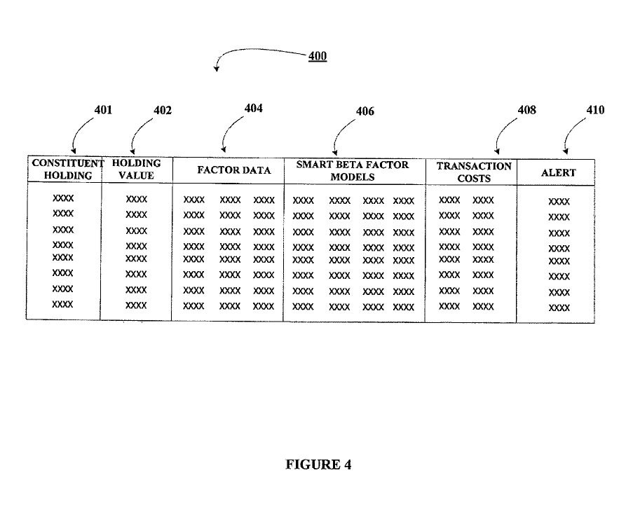

FIG. 3 illustrates an exemplary user interface displaying composite portfolio data for a plurality of customers 300. As shown in FIG. 3, the user interface includes account numbers 301, last name (of customer) 302, account value 304, one or more smart beta factor models 306, risk factor 308, income factor 310, and projected rate total return 312. The smart beta factor models include Qualified Replacement Property (QRP) score, Momentum (MOM) score, Quality Factor, Capital score, Intrinsic Value (Int Val) score, Relative Value (Rel Val) score, Value-Momentum (Val Mo) score, Price Momentum (Px Mo) score, and Analyst Revision Model (ARM) score. The user interface 300 also includes additional data, such as risk factor 308, income factor 310, and projected rate of return 312. Some of this data may be calculated based on retrieved factor data. For example, retrieved factor data may be used to calculate the projected total return 312 of each constituent holding. Thereafter, the projected total returns for multiple constituent holdings may be aggregated to calculate the projected total return 312 of each portfolio. In a particular embodiment, each portfolio may be further selectable by a user, where selecting a particular portfolio results in the display of a further user interface that includes the allocation of the portfolio's constituent holdings. In some embodiments, the system may be configured to characterize the portfolio and/or the one or more investment accounts. In this regard, the system may be configured to characterize the percentile ranking associated with the one or more smart beta factor models. By way of example, the value beta factor associated with the investment account may be characterized as either above average, average, or below average. In this way, the system may provide useful information to address the corrective direction of the portfolio and/or the one or more investment accounts. FIG. 4 illustrates an exemplary user interface displaying the asset data for a customer 400. As shown in FIG. 4, the user interface includes constituent holdings 401, holding value 402, factor data 404, smart beta factor models 406, transaction costs 408, and alerts 410. The smart beta factor models 406 illustrated in user interface 400 for each constituent holding may be similar to the one or more smart beta factor models 306 illustrated in user interface 300 for a plurality of portfolios. In one aspect, the smart beta factor models 406 illustrated in user interface 400 for each constituent holding may be distinct from the one or more smart beta factor models 306 illustrated in user interface 300 for a plurality of portfolios. In addition to smart beta factor models 406, the user interface 400 includes factor data. As described herein, the factor data 404 may include various metrics such as price, earnings, cash flow, market capitalization, volatility, price to earnings, price to book value, dividend yield, and the like. In some instances, such factor data 404 may include rankings, projections, and/or recommendations from analysts. In some embodiments, the user interface 400 includes transaction costs 408, i.e., costs incurred by the customer from modifying (e.g., buying, selling, or holding) each of the constituent holding. Additionally, the user interface 400 includes alerts 410. In one aspect, the alerts may be a pop up message, an audible tone, a voice message, a blinker, or the like. In one aspect, the alert 410 may include an indication of the recommended action associated with the threshold satisfied.

In some embodiments, the graphical user interface 300, 400 may be updated periodically. In this regard, the system may be configured to generate the graphical user interface 300, 400 and initiate the presentation of the graphical user interface 300, 400 to the user periodically based on the most recent factor data, updated scores, updated percentile rankings, and asset allocation changes. In one aspect, the system may be configured to generate the graphical user interface 300, 400 if at least one of the one or more smart beta factor models is updated. In this regard, the graphical user interface 300, 400 generate may include updated values for smart beta factor model that was updated and a consequential effect of the updated smart beta factor model on each of the one or more smart beta factor models in the graphical user interface 300, 400.

In some embodiments, the system may be configured to customize the generation of the graphical user interface 300, 400 based on updated information associated with a combination of smart beta factor models. In this way, any changes in percentile ranking for smart beta factor models associated with individual constituent holdings are reflected in the percentile ranking of the portfolio and/or the investment account comprising the individual constituent holdings. In some embodiments, the customer and/or the user may use the information presented on the graphical user interface 300, 400 to modify the constituent holdings in the investment account and/or the portfolio to obtain a better score and/or percentile ranking for the investment account and/or the portfolio.

In some embodiments, the system may be configured to generate graphical user interfaces similar to the graphical user interface 300, 400 to present information associated with the constituent holdings, investment accounts, and/or portfolio to the entity (e.g., branch, complex, region, company, or the like). In doing so, the entity may be provided with information associated with one or more portfolios managed by each user associated with the entity. Typically, the information may include, but is not limited to, the smart beta factor models, the percentile rankings associated with the smart beta factor models, portfolio value (e.g., cumulative monetary value of the assets associated with the portfolio), or the like. In response to receiving the information, the entity may analyze the information to review each user and the one or more investment accounts and/or portfolios managed by the user. In some embodiments, reviewing the user may include determining a cumulative smart beta factor model concentration for the one or more portfolios managed by the user. In one aspect, determining a cumulative smart beta factor model concentration may include determining whether the one or more specific smart beta factor models are over concentrated or under concentrated. In response to determining a concentration, the system may be configured to complement the determined concentration with one or more additional factors (e.g., constituent holdings with a complementing skew in the smart beta factor models). In some other embodiments, the system may be configured to determine a risk assessment associated with the one or more investment accounts and/or portfolios based on the cumulative percentile ranking associated with the smart beta factor models.

In some embodiments, the system may be configured to generate graphical user interfaces similar to the graphical user interface 300, 400 to present information associated with the constituent holdings, investment accounts, and/or portfolio for reporting purposes.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for efficiently identifying investment opportunities for non-managed investment accounts, the system comprising:
a non-transitory computer-readable storage medium;
at least one computer processor; and
a module stored in the memory and executable by the computer processor, the module comprising computer-executable instructions for causing the computer processor to be configured to:
determine asset allocation of a portfolio, wherein the portfolio comprises one or more constituent holdings;
retrieve factor data for the one or more constituent holdings from a network of distributed servers, wherein the factor data is associated with one or more smart beta factor models;
determine a score for the one or more smart beta factor models for each of the one or more constituent holdings associated with the portfolio based on at least the factor data;
determine a ranking for the one or more smart beta factor models associated with each of the one or more constituent holdings associated with the portfolio based on at least the determined score, wherein the ranking comprises a percentile ranking;
receive one or more threshold conditions associated with the portfolio, wherein the threshold conditions are associated with the ranking of the one or more smart beta factor models associated with each of the one or more constituent holdings, wherein each of the one or more threshold conditions are associated with a recommended action, wherein the recommended action is associated with the one or more constituent holdings in the portfolio;
determine whether the ranking of the one or more smart beta factor models for each of the one or more constituent holdings associated with the portfolio satisfies at least one of the one or more threshold conditions; and
generate an alert on a graphical user interface for display on a user device, wherein the alert comprises an indication that at least one of the one or more threshold conditions for at least one of the one or more constituent holdings associated with the portfolio has been satisfied.

2. The system of claim 1, wherein the module further comprises computer-executable instructions for causing the computer processor to:
display on the graphical user interface on the user device, the ranking for the one or more smart beta factor models associated with each of the one or more constituent holdings associated with the portfolio.

3. The system of claim 1, wherein the module comprises computer-executable instructions for causing the computer processor to:
retrieve from a database, the recommended action associated with the at least one of the one or more threshold conditions;
initiate a presentation of a second alert on a graphical user interface for display on a customer device, wherein the second alert comprises the indication that at least one of the one or more threshold conditions associated with the portfolio has been satisfied and the recommended action retrieved from the database; and
receive an authorization from a customer device to execute the recommended action based on at least the second alert.

4. The system of claim 3, wherein the module comprises computer-executable instructions for causing the computer processor to:
receive an indication from the customer device to modify at least one of the one or more threshold conditions;
determine whether the ranking of the one or more smart beta factor models associated with each of the one or more constituent holdings associated with the portfolio satisfies at least one of the one or more modified threshold conditions;
generate a third alert on a graphical user interface for display on the user device, wherein the third alert comprises an indication that at least one of the one or more modified threshold conditions associated with the portfolio has been satisfied.

5. The system of claim 1, wherein the module comprises computer-executable instructions for causing the computer processor to:
receive an indication from the customer device to modify the recommend action associated with the at least one of the one or more constituent holdings in the portfolio; and
update the recommended action stored in the database with the modified recommended action based on at least the received indication from the customer device.

6. The system of claim 1, wherein the module comprises computer-executable instructions for causing the computer processor to:
continuously retrieve updated factor data for each of the one or more constituent holdings;
continuously update the score for the one or more smart beta factor models associated with each of the one or more constituent holdings of the portfolio based on at least continuously retrieving updated factor data and the asset allocation; and
continuously update the ranking of each of the one or more smart beta factor models associated with each of the one or more constituent holdings associated with the portfolio based on at least the continuously updated score.

7. The system of claim 1, wherein the module comprises computer-executable instructions for causing the computer processor to:
receive an indication from the user device to initiate the execution of the recommended action;
execute the recommended action, wherein executing the recommended action comprises modifying at least one of the one or more constituent holdings associated with the portfolio; and
determine an updated score and an updated ranking for one or more smart beta factor models associated with each of the one or more constituent holdings associated with the portfolio based on at least receiving an indication that the recommended action has been executed.

8. A computer program product for efficiently identifying investment opportunities for non-managed investment accounts, the computer program product comprising a non-transitory computer-readable storage medium having computer-executable instructions for causing a computer processor to be configured to:
determine asset allocation of a portfolio, wherein the portfolio comprises one or more constituent holdings;
retrieve factor data for the one or more constituent holdings from a network of distributed servers, wherein the factor data is associated with one or more smart beta factor models;
determine a score for the one or more smart beta factor models for each of the one or more constituent holdings associated with the portfolio based on at least the factor data;
determine a ranking for the one or more smart beta factor models associated with each of the one or more constituent holdings associated with the portfolio based on at least the determined score, wherein the ranking comprises a percentile ranking;
receive one or more threshold conditions associated with the portfolio, wherein the threshold conditions are associated with the ranking of the one or more smart beta factor models associated with each of the one or more constituent holdings, wherein each of the one or more threshold conditions are associated with a recommended action, wherein the recommended action is associated with the one or more constituent holdings in the portfolio;
determine whether the ranking of the one or more smart beta factor models for each of the one or more constituent holdings associated with the portfolio satisfies at least one of the one or more threshold conditions; and
generate an alert on a graphical user interface for display on a user device, wherein the alert comprises an indication that at least one of the one or more threshold conditions for at least one of the one or more constituent holdings associated with the portfolio has been satisfied.

9. The computer program product of claim 8, wherein the non-transitory computer-readable storage medium having computer-executable instructions for causing a computer processor to be configured to:
display on the graphical user interface on the user device, the ranking for the one or more smart beta factor models associated with each of the one or more constituent holdings associated with the portfolio.

10. The computer program product of claim 8, wherein the non-transitory computer-readable storage medium having computer-executable instructions for causing a computer processor to be configured to:
retrieve from a database, the recommended action associated with the at least one of the one or more threshold conditions;
initiate a presentation of a second alert on a graphical user interface for display on a customer device, wherein the second alert comprises the indication that at least one of the one or more threshold conditions associated with the portfolio has been satisfied and the recommended action retrieved from the database; and
receive an authorization from a customer device to execute the recommended action based on at least the second alert.

11. The computer program product of claim 10, wherein the non-transitory computer-readable storage medium having computer-executable instructions for causing a computer processor to be configured to:
receive an indication from the customer device to modify at least one of the one or more threshold conditions;
determine whether the ranking of the one or more smart beta factor models associated with each of the one or more constituent holdings associated with the portfolio satisfies at least one of the one or more modified threshold conditions;
generate a third alert on a graphical user interface for display on the user device, wherein the third alert comprises an indication that at least one of the one or more modified threshold conditions associated with the portfolio has been satisfied.

12. The computer program product of claim 8, wherein the non-transitory computer-readable storage medium having computer-executable instructions for causing a computer processor to be configured to:
receive an indication from the customer device to modify the recommend action associated with the at least one of the one or more constituent holdings in the portfolio; and
update the recommended action stored in the database with the modified recommended action based on at least the received indication from the customer device.

13. The computer program product of claim 8, wherein the non-transitory computer-readable storage medium having computer-executable instructions for causing a computer processor to be configured to:
continuously retrieve updated factor data for each of the one or more constituent holdings;
continuously update the score for the one or more smart beta factor models associated with each of the one or more constituent holdings based on at least continuously retrieving updated factor data and the asset allocation; and
continuously update the ranking of each of the one or more smart beta factor models associated with each of the one or more constituent holdings associated with the portfolio based on at least the continuously updated score.

14. The computer program product of claim 8, wherein the non-transitory computer-readable storage medium having computer-executable instructions for causing a computer processor to be configured to:
receive an indication from the user device to initiate the execution of the recommended action;
execute the recommended action, wherein executing the recommended action comprises modifying at least one of the one or more constituent holdings associated with the portfolio; and
determine an updated score and an updated ranking for one or more smart beta factor models associated with each of the one or more constituent holdings associated with the portfolio based on at least receiving an indication that the recommended action has been executed.

15. A computerized method for efficiently identifying investment opportunities for non-managed investment accounts, the method comprising:
determining, using a computing device processor, asset allocation of a portfolio, wherein the portfolio comprises one or more constituent holdings;
retrieving, using a computing device processor, factor data for the one or more constituent holdings from a network of distributed servers, wherein the factor data is associated with one or more smart beta factor models;
determining, using a computing device processor, a score for the one or more smart beta factor models for each of the one or more constituent holdings associated with the portfolio based on at least the factor data;
determining, using a computing device processor, a ranking for the one or more smart beta factor models associated with each of the one or more constituent holdings associated with the portfolio based on at least the determined score, wherein the ranking comprises a percentile ranking;
receiving, using a computing device processor, one or more threshold conditions associated with the portfolio, wherein the threshold conditions are associated with the ranking of the one or more smart beta factor models associated with each of the one or more constituent holdings, wherein each of the one or more threshold conditions are associated with a recommended action, wherein the recommended action is associated with the one or more constituent holdings in the portfolio;
determining, using a computing device processor, whether the ranking of the one or more smart beta factor models for each of the one or more constituent holdings associated with the portfolio satisfies at least one of the one or more threshold conditions; and
generating, using a computing device processor, an alert on a graphical user interface for display on a user device, wherein the alert comprises an indication that at least one of the one or more threshold conditions for at least one of the one or more constituent holdings associated with the portfolio has been satisfied.

16. The method according to claim 15, comprising:
displaying on the graphical user interface on the user device, the ranking for the one or more smart beta factor models associated with each of the one or more constituent holdings associated with the portfolio.

17. The method according to claim 15, comprising:
retrieving from a database, the recommended action associated with the at least one of the one or more threshold conditions;
initiating a presentation of a second alert on a graphical user interface for display on a customer device, wherein the second alert comprises the indication that at least one of the one or more threshold conditions associated with the portfolio has been satisfied and the recommended action retrieved from the database; and
receiving an authorization from a customer device to execute the recommended action based on at least the second alert.

18. The method according to claim 17, comprising, wherein the non-transitory computer-readable storage medium having computer-executable instructions for causing a computer processor to be configured to:
receiving an indication from the customer device to modify at least one of the one or more threshold conditions;
determining whether the ranking of the one or more smart beta factor models associated with each of the one or more constituent holdings associated with the portfolio satisfies at least one of the one or more modified threshold conditions;
generating a third alert on a graphical user interface for display on the user device, wherein the third alert comprises an indication that at least one of the one or more modified threshold conditions associated with the portfolio has been satisfied.

19. The method according to claim 15, comprising:
receiving an indication from the customer device to modify the recommend action associated with the at least one of the one or more constituent holdings in the portfolio; and
updating the recommended action stored in the database with the modified recommended action based on at least the received indication from the customer device.

20. The method according to claim 15, comprising:
determining, using a computing device processor, a score for the one or more smart beta factor models for the portfolio based on at least the factor data and the asset allocation;
determining, using a computing device processor, a ranking for the one or more smart beta factor models associated with the portfolio based on at least the determined score;
displaying on the graphical user interface on the user device, the ranking for the one or more smart beta factor models associated with the portfolio.
